(19) United States
(12) Patent Application Publication
(10) Pub. No.: US 2012/0051053 A1
(43) Pub. Date: Mar. 1, 2012

(54) LIGHT PANEL FRAME WITH WATERPROOFING LUMINOUS MODULE

(75) Inventor: Shuei-Tian Cai, Taichung City (TW)

(73) Assignee: SAFETY TRAFFIC EQUIPMENT CO., LTD., Taichung City (TW)

(21) Appl. No.: 12/872,492

(22) Filed: Aug. 31, 2010

(51) Int. Cl. F21V 21/00

(52) U.S. Cl. 362/249.02

(57) ABSTRACT

A light panel frame with waterproofing luminous module used to assemble a light panel for illumination and marking purposes. The light panel frame has a frame body with a locating portion and an assembly side. A slot is set at the assembly side. A luminous module chamber is set into the frame body correspondingly to the slot. A waterproofing luminous module is set into the luminous module chamber and has a pedestal, LED luminous member and waterproof covering. The pedestal includes a holding portion and an opening side. The LED luminous member is incorporated into the holding portion of the pedestal and has a circuit board, a plurality of LED units and an electrical wire. The irradiation end of LED units faces the opening side of the pedestal. The waterproof covering is filled into the holding portion of the pedestal so as to seal off at least the circuit board.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a frame of a light panel, and more particularly to an innovative one which is configured with a waterproofing luminous module.

2. Description of Related Art Including Information Disclosed Under 37 CFR 1.97 and 37 CFR 1.98.

The “light panel” involved in the present invention refers to the exit indicator or advertising marking panel widely applied to public spaces, commercial and residential buildings.

Said light panel is generally intended for illumination through lateral light-projecting patterns from an LED on the frame, thus saving much power consumption than conventional lamp boxes. Moreover, due to its thin-profile and much lower cost of materials and assembly, there is a growing trend that this kind of light panel will replace traditional similar products.

However, there is still a room for improvement of such a light panel, for instance, waterproofing the structure of the luminous body. As the conventional light panel is designed to be installed indoors, the assembly portion of the luminous body is only assembled onto the frame without any waterproofing. However, the existing light panels are gradually used outdoors as an indicator or ads marker, increasing greatly the possibility of water ingress. In such cases, the light panel frame without waterproofing will meet problems such as safety hazards, higher damage or shorter service life.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

The enhanced efficacy of the present invention is as follows:

Based on the unique structural configuration of the present invention wherein “the light panel frame with waterproofing luminous module” mainly comprises a pedestal, a LED luminous member and a waterproof covering, the circuit structure of the light panel frame is provided with waterproofing functions. The circuit board and LED pins are vulnerable to moisture or ingress of water and are sealed by a waterproof covering. The light panel frame is preferably suitable for indoor/outdoor applications with much higher safety performance, lower damage and longer service life.

The improvements brought about by this invention are as follows:

First, based on the structural configuration wherein a front slot is laterally set onto the frame body to insert the diffuser plate, the diffuser plate can be used to arrange patterns, figures or letters other than diffusion of rays. So, the diffuser plate with graphic designs can be replaced without affecting the light panel, thus saving the cost.

Second, based on the structural configuration wherein the slot is laterally extended to form a troughed portion, it is possible to accommodate the electrical wire of the LED luminous member for more convenient wiring of the circuit.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an exploded perspective view of the preferred embodiment of the present invention.

FIG. 2 is a schematic view of the preferred embodiment of the present invention.

FIG. 3 is a partial sectional view of the preferred embodiment of the present invention.

FIG. 4 is a schematic view of the assembled preferred embodiment of the present invention.

FIG. 5 is a schematic view of the present invention with two slots.

FIG. 6 is a schematic view of another preferred embodiment of the present invention.

FIG. 7 is a schematic view of another preferred embodiment of the present invention.

### DETAILED DESCRIPTION OF THE INVENTION

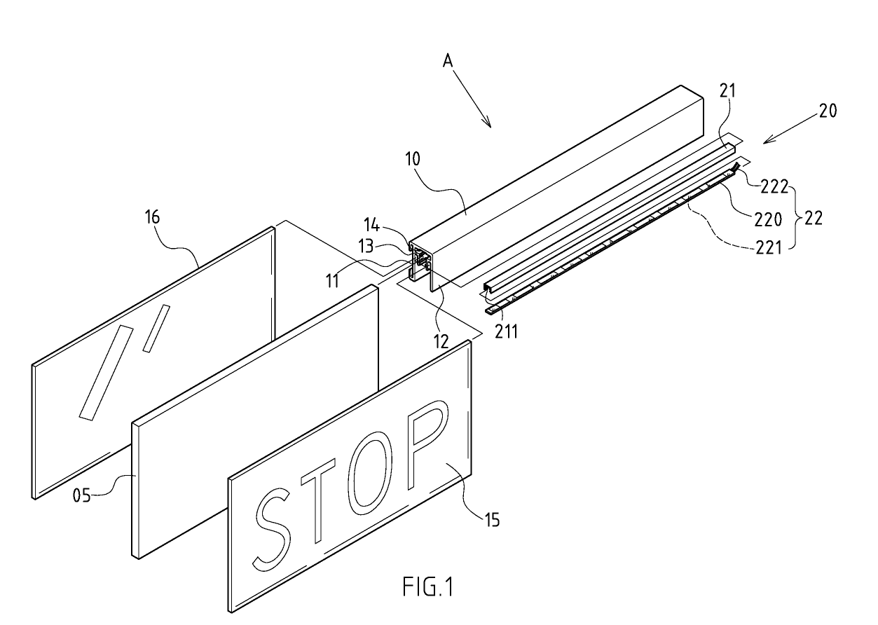

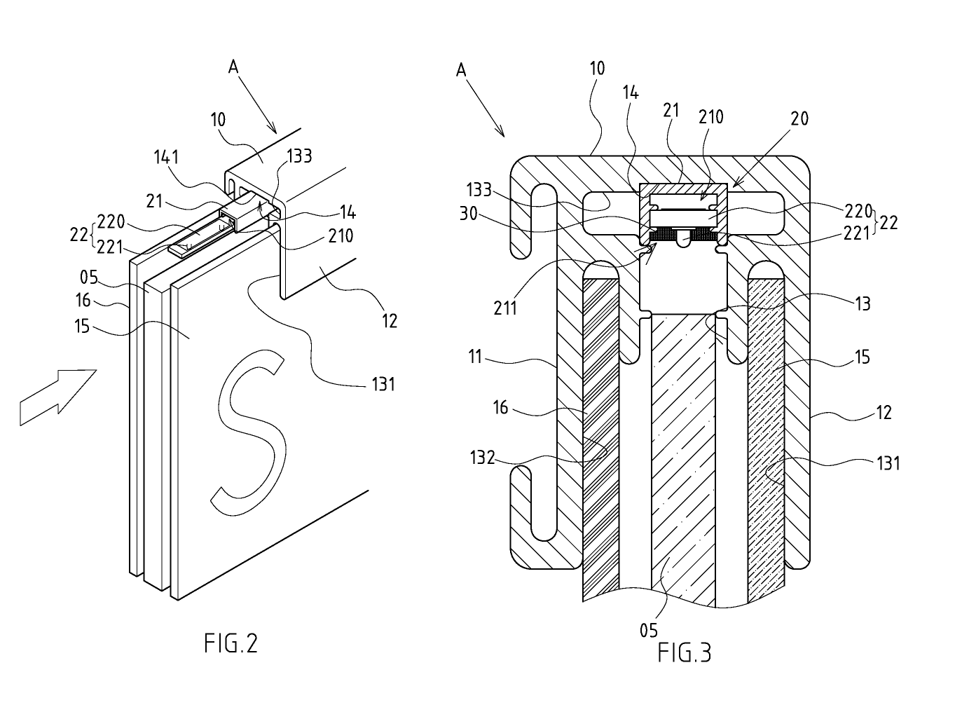

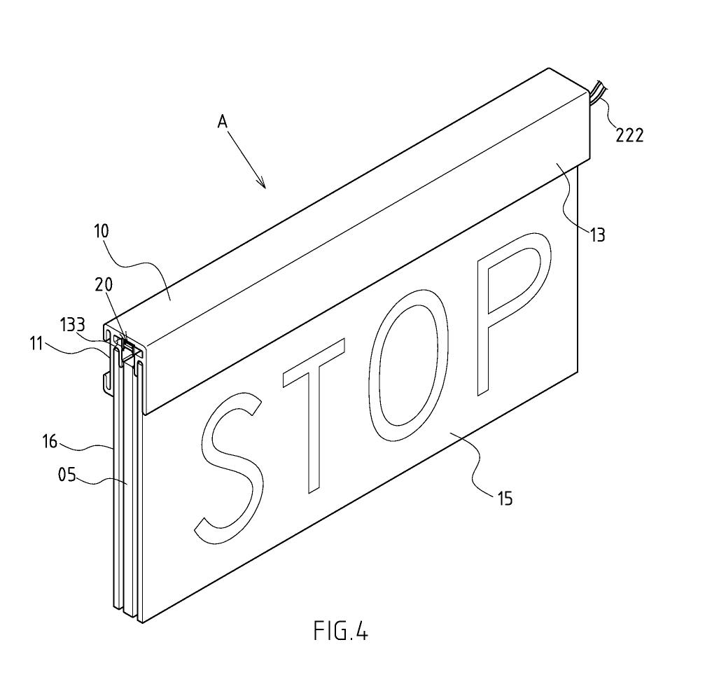

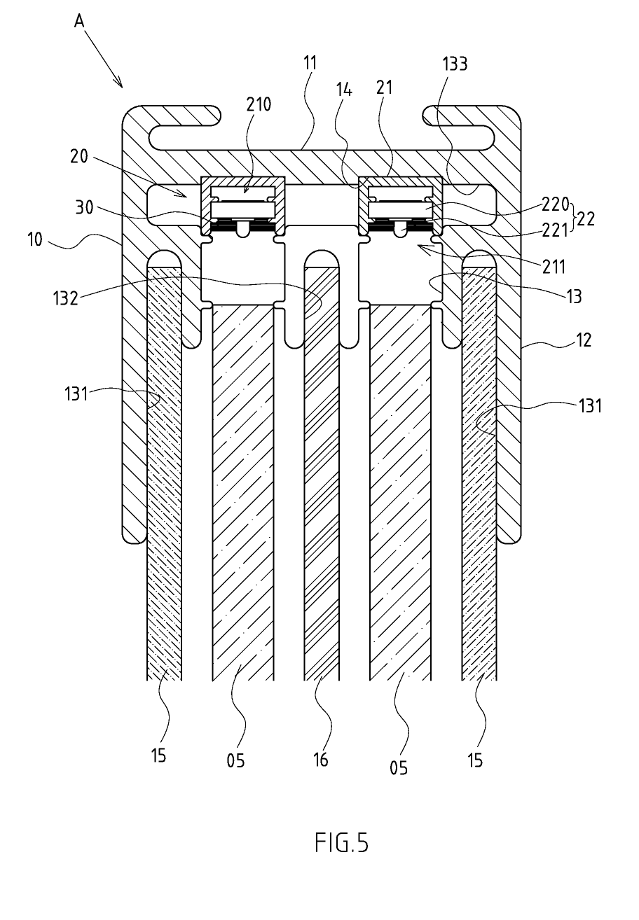

FIGS. 1-3 depict preferred embodiments of a light panel frame of the present invention with a waterproofing luminous module, which, however, are provided for only explanatory objective for patent claims. Said light panel frame A is used to assemble a light panel 05 (the configuration is not limited, e.g.: a rectangular frame shown in FIGS. 1-5, or an octagonal frame shown in FIG. 6) for intended illumination and marking purposes.

The light panel frame A includes a frame body 10, having a locating portion 11 and an assembly side 12. At least one slot 13 is set at the assembly side 12 of the frame body 10 for insertion and mating of the light panel 05. At least one luminous module chamber 14 is set into the frame body 10 correspondingly to the slot 13. At least one waterproofing luminous module 20 is set into the luminous module chamber 14. The waterproofing luminous module 20 has a pedestal 21, having a holding portion 210 and an opening side 211.

A LED luminous member 22 is incorporated into the holding portion 210 of the pedestal 21, and includes a circuit board 220, a plurality of LED units 221 arranged at interval onto the circuit board 220 and an electrical wire 222. Of which, the irradiation end of LED units 221 faces the opening side 211 of the pedestal 21.

A waterproof covering 30 is filled into the holding portion 210 of the pedestal 21 within the range of the opening side 211 and circuit board 220, so as to seal off at least the circuit board 220 in the LED luminous member 22.

Of which, said locating portion 11 is set into a groove (e.g.: of dovetail cross section) at one side of the frame body 10.

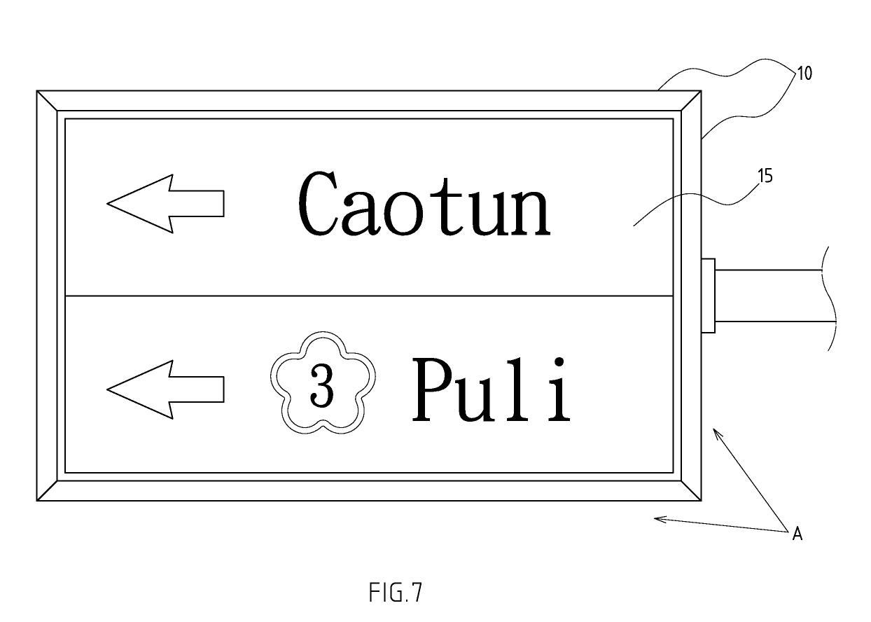

Of which, the frame body 10 is incorporated linearly onto one side of the light panel 05, or incorporated circularly onto the periphery of the light panel 05 (shown in FIGS. 6, 7).

Of which, the frame body 10 is provided with a front slot 131 and a rear slot 132 at both sides of the slot 13. A diffuser plate 15 is inserted into the front slot 131, and a backing plate 16 inserted into the rear slot 132. Other than diffusion of rays, the diffuser plate 15 can be used to arrange patterns, figures or letters to generate either of the preset decoration, marking, indication and advertisement functions. Referring to FIGS. 6 and 7, the diffuser plate 15 can be used as road sign or large guide sign on highways. Certainly, the light panel 05 can also be configured with patterns, figures or letters. In this preferred embodiment, the diffuser plate 15 with graphic designs can be replaced without affecting the light panel 05, since the light panel 05 is generally made of acrylic sheets with higher cost. The diffuser plate 15 is made of thin-profile sheets with lower cost.

Of which, the waterproof covering 30 is covered onto higher position of the LED units 221 of the LED luminous member 22, so that the irradiation end of LED units 221 can be protruded out of the waterproof covering 30.

Of which, the waterproofing luminous module 20 is configured into an elongated pattern, whilst the luminous module chamber 14 is configured into a long grooved pattern, and an inlet 141 is formed at the end for incorporation of the waterproofing luminous module 20.

The slot 13 is laterally extended to form a troughed portion 133 to accommodate the electrical wire 222 of the LED luminous member 22.

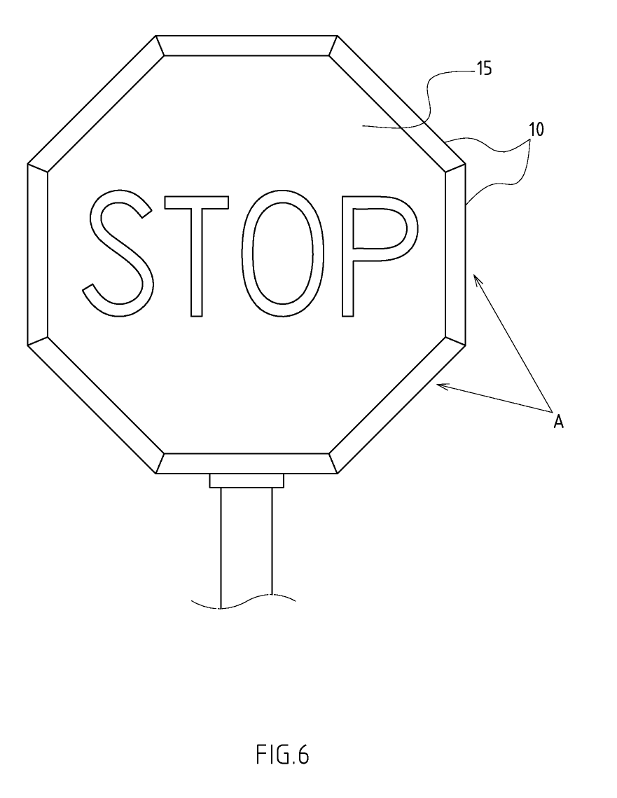

Based on above-specified structural configuration, one of the core features of the light panel frame A of the present invention lies in that, the waterproof covering 30 is filled into the holding portion 210 of the pedestal 21 within the range of the opening side 211 and circuit board 220, so as to seal off at least the circuit board 220 in the LED luminous member 22. Of which, said slot 13 is available with several configurations. Referring to FIGS. 1-4, the slot 13 is of a single configuration, allowing formation of a front slot 131 for insertion of the diffuser plate 15 and a rear slot 132 for insertion of the backing plate 16. Or, referring to FIG. 5, the slot 13 is of a spaced configuration, wherein a rear slot 132 is formed between two slots 13 to insert the backing plate 16, and a front slot 131 is set externally onto two slots 13 for insertion of the diffuser plate 15, enabling two-sided visualization by the users.

1. A light panel frame with a waterproofing luminous module, said light panel frame is used to assemble a light panel for intended illumination and marking purposes; the light panel frame comprising:
a frame body having a locating portion and an assembly side;
at least one slot set at the assembly side of the frame body for insertion and mating of the light panel;
at least one luminous module chamber set into the frame body correspondingly to the slot;
at least one waterproofing luminous module, set into the luminous module chamber; the waterproofing luminous module comprising:
a pedestal having a holding portion and an opening side;
an LED luminous member incorporated into the holding portion of the pedestal having a circuit board, a plurality of LED units arranged at interval onto the circuit board and an electrical wire; of which an irradiation end of LED units faces the opening side of the pedestal; and
a waterproof covering filled into the holding portion of the pedestal to seal off at least the circuit board in the LED luminous member.

2. The structure defined in claim 1, wherein said locating portion is set into a groove at one side of the frame body.

3. The structure defined in claim 1, wherein the frame body is incorporated linearly onto one side of the light panel, or incorporated circularly onto the periphery of the light panel.

4. The structure defined in claim 1, wherein the frame body is provided with a front slot and a rear slot at both sides of the slot; a diffuser plate is inserted into the front slot, and a backing plate inserted into the rear slot.

5. The structure defined in claim 1, wherein the waterproof covering is covered onto higher position of the LED units of the LED luminous member, so that the irradiation end of LED units can be protruded out of the waterproof covering.

6. The structure defined in claim 1, wherein the waterproofing luminous module is configured into an elongated pattern, whilst the luminous module chamber is configured into a long grooved pattern, and an inlet is formed at the end for incorporation of the waterproofing luminous module.

7. The structure defined in claim 1, wherein the slot is laterally extended to form a troughed portion to accommodate the electrical wire of the LED luminous member.
